(19) United States
(12) Patent Application Publication
(10) Pub. No.: US 2026/0236324 A1
(43) Pub. Date: Aug. 13, 2026

(54) WORKLOAD PLACEMENT BASED ON ENERGY SCORE

(71) Applicant: Rakuten Symphony, Inc., Tokyo (JP)

(72) Inventors: Sree Nandan Atur, San Mateo, CA (US); Mruthyunjaya Navali, Boston, MA (US)

(21) Appl. No.: 19/051,854

(22) Filed: Feb. 12, 2025

(51) Int. Cl. G06F 9/50; G06F 9/48

(52) U.S. Cl. CPC G06F 9/5094; G06F 9/4881

(57) ABSTRACT

A selected node of a plurality of candidate nodes in a network environment is selected by retrieving a current processor utilization for each candidate node of a plurality of candidate nodes of the plurality of nodes. An estimated additional processor utilization resulting from the application instance is determined. For each node of the plurality of candidate nodes, a scheduler determines a delta power consumption according to the current processor utilization, the estimated additional processor utilization, and the processing device allocation using benchmark data for the each node. The scheduler selects a node of the plurality of candidate nodes having a lowest delta power consumption as a selected node and invokes installation of the application instance on the selected node.

### FIELD

The present disclosure relates to workload placement based on an energy score.

### BACKGROUND

The information disclosed in this background section is only for enhancement of understanding of the general background of the disclosure and should not be taken as an acknowledgement or any form of suggestion that this information forms the prior art already known to a person skilled in the art.

Processing devices may be composed of multiple cores each of which may be allocated and used independently. Accordingly, each core may have different utilization at any given time. In addition, each core may operate in one of many states (“cstates”), each of which has a different energy consumption level. The lower the power consumption of a cstate the lower the availability, e.g., the more steps that must be performed before a core at that cstate is able to execute instructions.

It would be an advancement in the art to reduce power consumption by processing devices of a computing node, particularly in large networks with many nodes.

### SUMMARY

In one aspect, a system includes a network environment including a plurality of nodes. The network environment may execute a scheduler configured to receive an instruction to instantiate an application instance in the network environment utilizing a processing device allocation. The scheduler may respond to the instruction by retrieving a current processor utilization for each candidate node of a plurality of candidate nodes of the plurality of nodes. The scheduler determines an estimated additional processor utilization resulting from the application instance. The scheduler determines a delta power consumption for each node according to the current processor utilization for the each node, the estimated additional processor utilization, and the processing device allocation using benchmark data for the each node. The scheduler selects a node of the plurality of candidate nodes having a lowest delta power consumption as a selected node and invokes installation of the application instance on the selected node.

In another aspect, a method includes receiving, by a scheduler executing in a network environment, an instruction to instantiate an application instance in the network environment utilizing a processing device allocation. In response to receiving the instruction to instantiate the application instance in the network environment, the scheduler retrieves a current processor utilization for each candidate node of a plurality of candidate nodes of the plurality of nodes. The scheduler determines an estimated additional processor utilization of the application instance. The scheduler determines a delta power consumption for each node according to the current processor utilization, the estimated additional processor utilization, and the processing device allocation using the benchmark data for the each node. The scheduler selects a selected node of the plurality of candidate nodes having a lowest delta power consumption as a selected and invokes installation of the application instance on the selected node.

In yet another aspect, a non-transitory computer-readable medium stores executable code that, when executed by one or more processing devices, causes the one or more processing devices to receive an instruction to instantiate an application instance in a network environment utilizing a processing device allocation. In response to receiving the instruction to instantiate the application instance in the network environment, the executable code causes the one or more processing devices to retrieve a current processor utilization for each candidate node of a plurality of candidate nodes of the plurality of nodes. An estimated additional processor utilization of the application instance is then determined. A delta power consumption is determined for each node according to the current processor utilization, the estimated additional processor utilization, and the processing device allocation using benchmark data for each node. A node of the plurality of candidate nodes having a lowest delta power consumption is selected as a selected node and installation of the application instance on the selected node is invoked.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 is a schematic block diagram of a network environment in which containers may be deployed in accordance with an embodiment;

FIG. 2 is a schematic block diagram showing components for implementing a cluster in accordance with an embodiment;

FIG. 3 is a process flow diagram of a method for collecting energy expenditure and CPU utilization data in accordance with an embodiment;

FIG. 4 is a process flow diagram of a method for selecting a node to implement a cluster based on energy expenditure and CPU utilization data in accordance with an embodiment;

FIG. 5 is a process flow diagram of a method for instantiating an application based on energy expenditure in accordance with an embodiment; and

FIG. 6 is a schematic block diagram of an example computing device suitable for implementing methods in accordance with embodiments of the disclosure

### DETAILED DESCRIPTION

The following detailed description of example embodiments refers to the accompanying drawings. The present disclosure provides illustrations and descriptions, but is not intended to be exhaustive or to limit the implementations to the precise form disclosed. Modifications and variations are possible in light of the present disclosure or may be acquired from practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

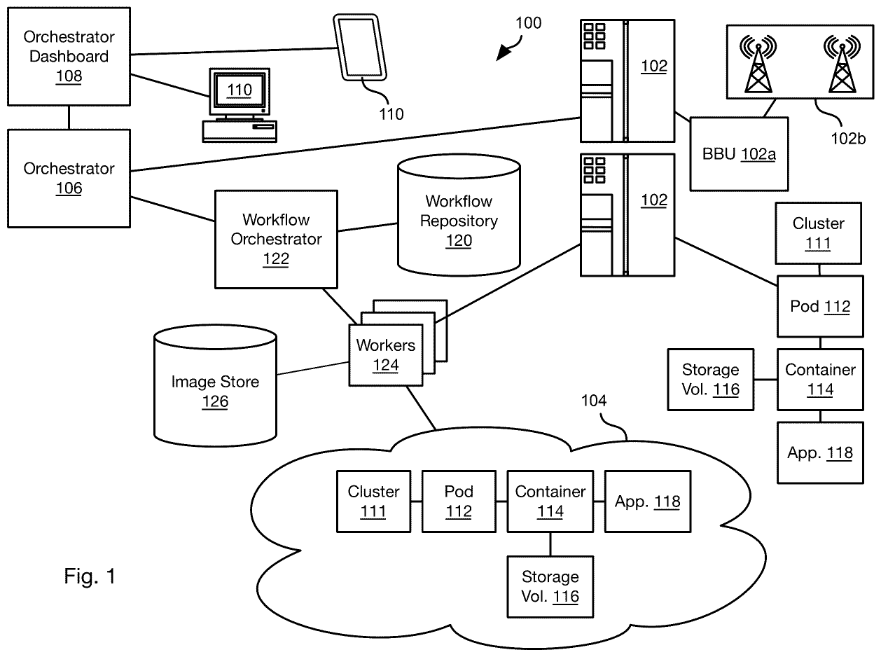

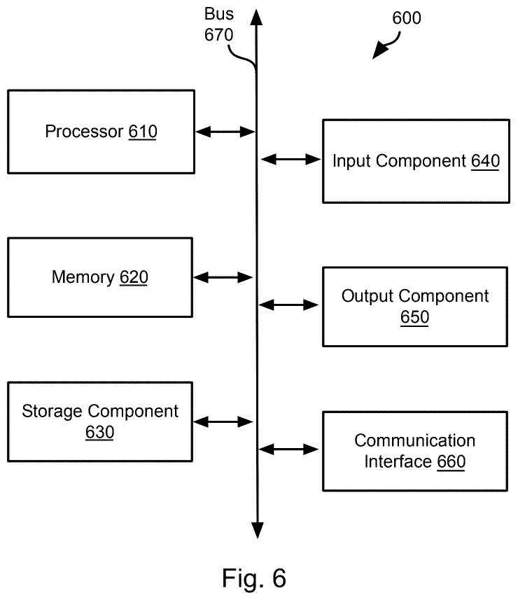

FIG. 1 illustrates an example network environment 100 in which the systems and methods disclosed herein may be used. The components of the network environment 100 may be connected to one another by a network such as a local area network (LAN), wide area network (WAN), the Internet, a backplane of a chassis, or other type of network. The components of the network environment 100 may be connected by wired or wireless network connections. The network environment 100 includes a plurality of servers 102. Each of the servers 102 may include one or more computing devices, such as a computing device having some or all of the attributes of the computing device 600 of FIG. 6.

Computing resources may also be allocated and utilized within a cloud computing platform 104, such as amazon web services (AWS), GOOGLE CLOUD, AZURE, or other cloud computing platform. Cloud computing resources may include purchased physical storage, processor time, memory, and/or networking bandwidth in units designated by the provider by the cloud computing platform. Accordingly, references to a server 102 herein may also refer to a virtualized server implemented by computing nodes of a cloud computing platform 104.

In some embodiments, some or all of the servers 102 may function as edge servers in a telecommunication network. The servers 102 may function as a distributed unit (DU) or central unit (CU) according to the open radio access network (O-RAN) standard. The servers 102 may implement a telecommunications cloud including DUs and CUs. For example, some or all of the servers 102 may be coupled to baseband units (BBU) 102a that provide translation between radio frequency signals output and received by antennas 102b, and digital data transmitted and received by the servers 102. For example, each BBU 102a may perform this translation according to a cellular wireless data protocol (e.g., 4G, 5G, etc.). In some embodiments, a BBU 102a may be a gNodeB according to the 5G protocol.

An orchestrator 106 provisions computing resources to application instances 118 of one or more different application executables, such as according to a manifest that defines requirements of computing resources for each application instance. The manifest may define dynamic requirements defining the scaling up or scaling down of a number of application instances 118 and corresponding computing resources in response to usage. The orchestrator 106 may include or cooperate with a utility such as KUBERNETES to perform dynamic scaling up and scaling down of the number of application instances 118. In some embodiments, the orchestrator 106 may be or include a service management and orchestration (SMO) platform according to the O-RAN standard.

An orchestrator 106 may execute on a computer system that is distinct from the servers 102 and is connected to the servers 102 by a network that requires the use of a destination address for communication, such as using a networking including ethernet protocol, internet protocol (IP), Fiber Channel, or other protocol, including any higher-level protocols built on the previously-mentioned protocols, such as user datagram protocol (UDP), transport control protocol (TCP), or the like.

The orchestrator 106 may cooperate with the servers 102 to initialize and configure the servers 102. For example, each server 102 may cooperate with the orchestrator 106 to obtain a gateway address to use for outbound communication and a source address assigned to the server 102 for use in inbound communication. The server 102 may cooperate with the orchestrator 106 to install an operating system on the server 102.

The orchestrator 106 may be accessible by way of an orchestrator dashboard 108. The orchestrator dashboard 108 may be implemented as a web server or other server-side application that is accessible by way of a browser or client application executing on a user computing device 110, such as a desktop computer, laptop computer, mobile phone, tablet computer, or other computing device.

The orchestrator 106 may cooperate with the servers 102 in order to provision computing resources of the servers 102 and instantiate components of a distributed computing system on the servers 102 and/or on the cloud computing platform 104. For example, the orchestrator 106 may ingest a manifest defining the provisioning of computing resources to, and the instantiation of, components such as a cluster 111, pod 112 (e.g., KUBERNETES pod), container 114 (e.g., DOCKER container), storage volume 116, and an application instance 118. The orchestrator may then allocate computing resources and instantiate the components according to the manifest.

The manifest may define requirements such as network latency requirements, affinity requirements (same node, same chassis, same rack, same data center, same cloud region, etc.), anti-affinity requirements (different node, different chassis, different rack, different data center, different cloud region, etc.), as well as minimum provisioning requirements (number of cores, amount of memory, etc.), performance or quality of service (QOS) requirements, or other constraints. The orchestrator 106 may therefore provision computing resources in order to satisfy or approximately satisfy the requirements of the manifest.

The instantiation of components and the management of the components may be implemented by means of workflows. A workflow is a series of tasks, executables, configuration, parameters, and other computing functions that are predefined and stored in a workflow repository 120. A workflow may be defined to instantiate each type of component (cluster 111, pod 112, container 114, storage volume 116, application instance, etc.), monitor the performance of each type of component, repair each type of component, upgrade each type of component, replace each type of component, copy (snapshot, backup, etc.) and restore from a copy each type of component, and other tasks. Some or all of the tasks performed by a workflow may be implemented using KUBERNETES or other utility for performing some or all of the tasks.

The orchestrator 106 may instruct a workflow orchestrator 122 to perform a task with respect to a component. In response, the workflow orchestrator 122 retrieves the workflow from the workflow repository 120 corresponding to the task (e.g., the type of task (instantiate, monitor, upgrade, replace, copy, restore, etc.) and the type of component. The workflow orchestrator 122 then selects a worker 124 from a worker pool and instructs the worker 124 to implement the workflow with respect to a server 102 or the cloud computing platform 104. The instruction from the orchestrator 106 may specify a particular server 102, cloud region or cloud provider, or other location for performing the workflow. The worker 124, which may be a container, then implements the functions of the workflow with respect to the location instructed by the orchestrator 106. In some implementations, the worker 124 may also perform the tasks of retrieving a workflow from the workflow repository 120 as instructed by the workflow orchestrator 122. The workflow orchestrator 122 and/or the workers 124 may retrieve executable images for instantiating components from an image store 126.

The servers 102 executing clusters 111 may have variable utilization over time and may therefore have additional clusters 111 instantiated thereon in response to utilization. Using the approach described herein, servers 102 are selected for instantiation of a cluster in order to reduce increases in energy utilization.

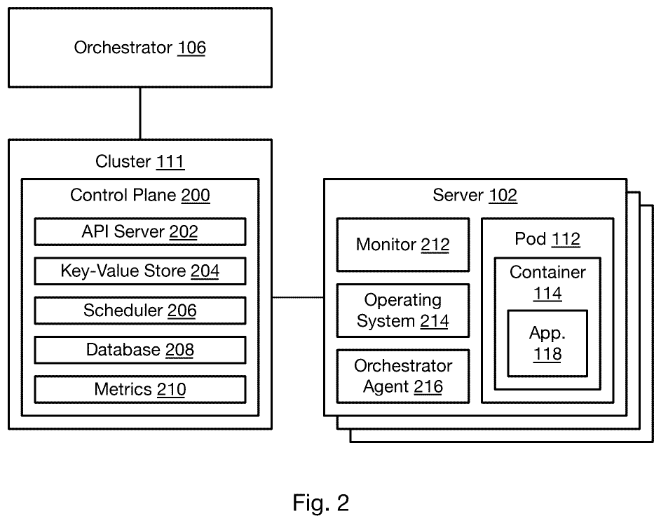

Referring to FIG. 2, a cluster 111 may be implemented with respect to one or more servers 102 using some or all of the illustrated components. The cluster 111 and the components indicated as being part of a cluster 111 may execute on one of the servers 102 implementing the pods 112 of the cluster 111 or may execute on a separate server 102.

A cluster 111 may include a control plane 200. The control plane 200 may include an application programming interface (API) server 202 configured to receive procedure calls (e.g., remote procedure calls (RPC)) from the orchestrator 106 to perform tasks, such as instantiating a pod 112, container 114, and/or application instance 118 on a server 102. For example, the API server 202 may be a KUBERNETES API server.

The control plane 200 may include a key-value store 204. The key-value store 204 may provide an exchange for communicating between components of a cluster 111. A component may post events to the key-value store 204 and evaluate the key-value store 204 to identify events that are relevant to the component, as discussed in greater detail below. The key-value store 204 may, for example, be the etcd daemon according to KUBERNETES.

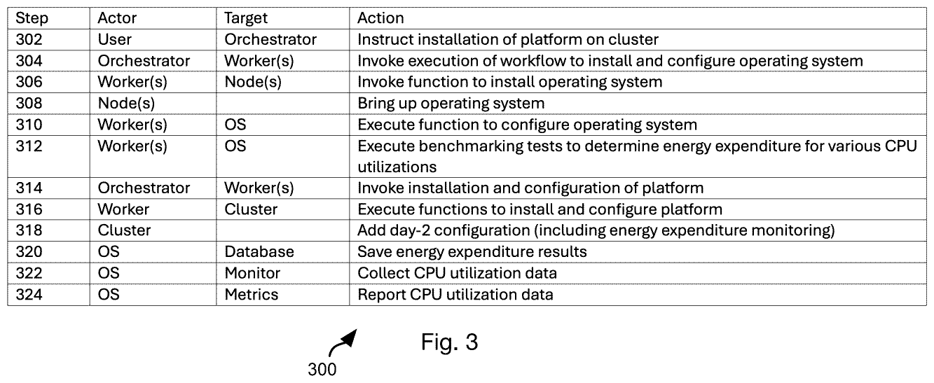

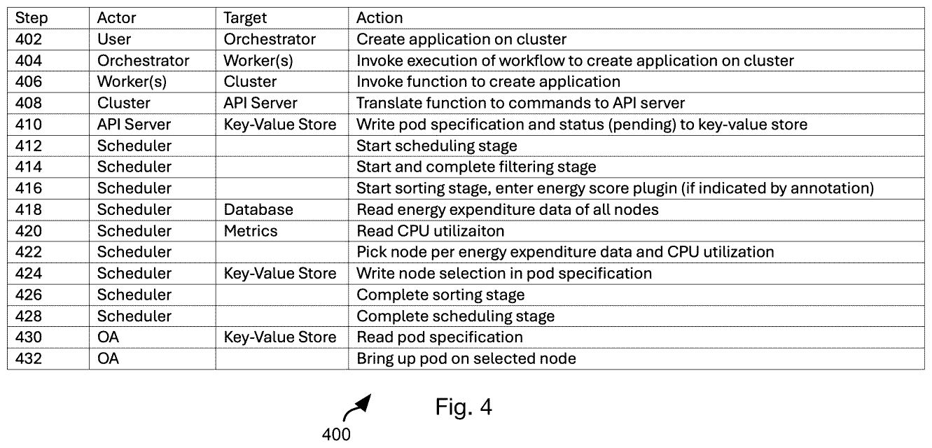

The control plane 200 may include a scheduler 206. The scheduler 206 may implement tasks in workflows for creating a cluster 111 and application instances 118 executing on a cluster 111. The scheduler 206 may select servers 102 for creation of pods 112 and for executing application instances 118 executing in pods 112. As discussed in greater detail below with respect to FIGS. 3 and 4, the scheduler 206 may take into account energy consumption as part of the server selection process.

The control plane 200 may include a database 208. The database 208 may store various items of data used by the scheduler 206. For example, the database 208 may store benchmark energy utilization data for each server 102 to facilitate selection of a server 102 to host a pod 112 as described in detail below with respect to FIGS. 3 and 4.

The control plane 200 may host metrics 210. The metrics 210 may include a module configured to collect and aggregate data from the servers 102 in order to characterize central processing unit (CPU) utilization by each server 102. As used herein, a CPU may refer to a processor core of a multi-core processing device or other processing device of a computing device that can be individually allocated.

The metrics 210 may include a module that communicates with a monitor 212 on the server 102, such as a cadvisor for monitoring CPU utilization of containers 114, such as DOCKER containers. For example, the metrics 210 may receive CPU utilization values for containers 114 executing on a server 102 for calculate an average CPU utilization for the server, e.g., an average of CPU utilization values for all CPUs during a time window preceding the time at which the average CPU utilization was calculated, e.g., a window of at least 1 second, 10 seconds, 1 minute, 5 minutes, 10 minutes, one hour, one day, or some longer period.

Each server 102 may further execute an operating system 214, such as LINUX, UNIX, WINDOWS, MACOS, or other operating system. The operating system 214 may be replaced with other operating contexts, such as a virtual machine.

Each server 102 may further execute an orchestrator agent 216. The orchestrator agent 216 may be an agent of the control plane 200 and may execute tasks assigned by the scheduler 206. For example, the orchestrator agent 216 may be a KUBERNETES Kubelet.

The server 102 may execute one or more pods 112, each executing one or more containers 114 and corresponding application instance 118. The instantiation of the containers 114 may be managed by the orchestrator agent 216 and monitoring of resource (e.g., CPU) utilization may be performed by the monitor 212.

Referring to FIGS. 2 and 3, KUBERNETES clusters 111 in a network environment 100, such as telecommunication cloud, may host a variety of network function (NF) workloads, with diverse resource requirements and performance characteristics. For example, central unit (CU) and 5G core network functions are latency sensitive and require high performance compute and network input/output (I/O). Distributed unit (DU) network NFs additionally require real-time performance guarantees.

To satisfy these guarantees, telecommunication NF workloads are implemented as guaranteed and burstable pods, which utilize high performance techniques like dedicated and isolated CPU resources, and dedicated network I/O resources. In addition, telecommunication NFs operate in resource constrained environments, where resource utilization and energy efficiency goals need to be balanced.

A standard KUBERNETES scheduler does not consider energy expenditure as one of the criteria when placing dedicated and burstable pods on different nodes of a cluster 111. Such a cluster 111 in a telecommunication cloud may be composed of servers from different manufacturers and different stock keeping units (SKUs) with varying energy usage. Servers from different manufacturers consume different amount of energy while in active and idle states. Servers from same manufacturer with different SKUs can also consume different amount of energy while in active and idle states. Servers from same manufacturer and same SKU but with different central processing unit (CPU) and memory configurations may also consume different amount of energy while in active and idle states.

The scheduling of dedicated and burstable pods typically includes two stages: scheduling and binding. A node is selected in the scheduling phase through filtering and sorting, and a pod is brought up on the selected node in the binding phase. Kubernetes by default provides many ways to score Node. For example, a node may be selected based on best fit/spread: the node with the highest score (more available resources relative to capacity). A node may be selected based on pack: the node with the least score (less available resources relative to capacity). Such a selection of the node does not take into account any knowledge of the additional energy expenditure of pod placement on the given server node.

The approach to selecting nodes described below with respect to FIGS. 2 and 3 can accommodate the complexity and diversity of telecommunication workloads while emphasizing the need for energy-aware scheduling to improve resource utilization and reduce energy consumption.

FIG. 3 illustrates a method 300 that may be performed using the network environment 100. The method 300 may presume that the servers 102 are in a bare metal condition, e.g., lack an operating system 214 or other operating context. However, in other scenarios, an operating system 214 or other operating context is already present such that steps of the method 300 relating to installation of an operating system 214 may be omitted.

At step 302, a user instructs the orchestrator 106 to install a platform on a cluster 111 in the network environment 100. As used herein, “the platform” may include an operating system 214 executing on each server 102. “The platform” may further include components executing on a node to facilitate cooperation with the cluster 111, such as an orchestrator agent 216, a container runtime interface (CRI) for managing installation and operation of containers, a monitor 212, or the like.

At step 304, the orchestrator 106 invokes execution of a workflow by the workers 124, e.g., by way of the workflow orchestrator 122. The workflow may be retrieved from the workflow repository 120 and may define the installation and configuration of an operating system 214 or other operating context on a plurality of nodes, e.g., servers 102. At step 306, the workers 124 may then communicate with each node of the plurality of nodes to invoke execution of functions on each to install the operating system 214 on each node.

At step 308, each node of the plurality of nodes will bring up, e.g., commence execution of the operating system 214. At step 310, the workers 124 may than instruct the operating system 214 to execute various functions to configure the operating system 214. One of these functions may include installing or otherwise deploying a benchmarking executable configured to artificially load the CPUs of each node and measure energy utilization for various CPU utilizations.

At step 312, the workers 124 instruct the operating system 214 of each node to execute benchmarking tests to determine energy expenditure for various CPU utilizations and the operating system 214 of each node will then execute the benchmarking tests.

The design space for the benchmarking tests may include testing scenarios defined for a plurality of values varying along at least two dimensions: number of CPUs that are allocated (N) and an average CPU utilization percentage (M) for the allocated CPUs. The range of values for N may be from a minimum number of CPUs to the total number of CPUs on the node. The minimum number of CPUs may be the number of CPUs required to execute the operating system 214, orchestrator agent 216, monitor 212, and/or other processes on the node that are not particular to a particular application instance 118.

The values for M may range from a minimum utilization (e.g., 0 percent or higher) and a maximum utilization (100 percent). The possible values for M may be constrained to be at fixed intervals, e.g., 0, 10, 20, 30, 40, 50, 60, 70, 80, 90, and 100. In some embodiments, to simplify benchmarking, the N CPUs for each test scenario (N, M) are constrained to be at the same utilization M. In other embodiments, a distribution of utilizations with an average utilization M is achieved.

In other embodiments, the design space defining each test scenario may include more dimensions than N and M. For example, M may be the average utilization of the N CPUs and various distribution of CPU utilizations may be tested for each value of N, e.g., identical utilization, and various degrees of inequality in utilization. Different values describing other factors such as memory utilization, network utilization, storage utilization, or other values may also be used to define test scenarios that are tested at step 312.

For a given test scenario, step 312 may include executing artificial workloads using the N CPUs of the test scenario to achieve the utilization defined by the test scenario. While doing so, step 312 may include reading one or more hardware registers of the node being tested in order to determine the power consumption of the CPUs during execution of the test scenario. For example, step 312 may include reading the model-specific register (MSR) of the CPUs, the running average power limit energy reporting (RAPL) register, or some other register. The hardware registers may be defined according to any CPU design known in the art, such as CPUs provided by INTEL, AMD, ARM, APPLE, or other manufacturer of CPUs. Specifically, step 312 may include reading a register indicating current power consumption of the N CPUs during loading according to a given test scenario. Reading the registers may be performed at regular intervals, e.g., every second or some other interval, to either (a) obtain a plurality of values that can be averaged and/or (b) to determine when the power consumption has stabilized such that an accurate sample may be read.

At step 314, the orchestrator 106 invokes installation and configuration of the platform by the workers 124 on the plurality of nodes. At step 316, the workers 124 may then execute the workflow for creation of the platform. For example, the workers 124 may instruct the cluster 111 at step 316 to execute functions required to install and configure the platform. These functions may include instantiating, on each node, the orchestrator agent 216, monitor 212, container runtime interface (CRI), or other executable facilitating cooperation of each node with the cluster 111. The cluster 111 may execute these instructions from the workers 124 at step 314.

At step 318 the cluster 111 may add a day-2 configuration. Day-2 configuration refers generally to functionalities executing on the plurality of nodes that are above or independent of installation of a software component, such as monitoring operation of a component, performing maintenance, performing lifecycle management (e.g., upgrading), or the like. The day-2 configuration may include software components for performing energy expenditure monitoring. In particular, during operation performing production tasks, the energy usage for given operating scenarios (number of CPUs allocated, utilization of CPUs, or other factor(s) described above for the test scenarios) may be measured and reported.

At step 320, the operating systems 214 of the plurality of nodes may store energy expenditure data acquired at step 312 in the database 208 of the cluster 111. At step 322 the operating system 214 of each node collects CPU utilization data for the node. At step 324 the operating system 214 of each node reports CPU utilization data to the cluster 111, such as to the metrics 210 of the cluster 111. For example, for a time window, the operating system 214 may collect and report the average CPU utilization for all allocated CPUs either as an individual average for each allocated CPU or as the average of the individual averages for all of the allocated CPUs. Steps 322 and 324 may be repeated periodically throughout operation of each node, such as upon elapse of each time window described above. Alternatively steps 322 and 324 may be performed only upon receiving a request from the cluster 111, such as when a pod needs to be scheduled, and CPU utilization is used to select a node.

FIG. 4 illustrates a method 400 of creating one or more application instances 118 on a node of a cluster. Instantiation and execution of the one or more application instances 118 may be managed by a KUBERNETES pod created on the node, though other orchestration approaches may also be used. As discussed in greater detail below, the node may be selected based on expected energy usage.

At step 402 a user instructs the orchestrator 106 to create one or more application instances on the cluster 111. At step 404, the orchestrator 106 instructs one or more workers 124 to execute the workflow to create one or more application instances 118 on the cluster 111. At step 406, the workers 124 instruct the cluster 111 to execute functions that create the one or more application instances 118 on the cluster 111. In response to the instructions of step 406, the cluster translates the functions into commands to the API server 202 at step 408. In response to the commands, the API server 202 writes a pod specification and a status (e.g., creation pending) to the key-value store 204. The pod specification may define a pod 112 including one or more containers 114 executing the one or more application instances.

The scheduler 206 detects the pod specification in the key-value store 204, such as due to the scheduler 206 listening for changes to the key-value store 204. At step 412, the scheduler 206 may start a scheduling stage in response to the scheduler 206 detecting the pod specification in the key-value store 204. Subsequent actions of the scheduler 206 in the method 400 may be parts of the scheduling stage.

At step 414, the scheduler 206 may start and complete a filtering stage. The filtering stage may include identifying a set of candidate nodes from the plurality of nodes of the cluster. Candidate nodes may be identified as satisfying affinity requirements (proximity to another application instance 118), anti-affinity requirements (separation from another application instance 118), performance requirements (available CPUs, memory, storage, network bandwidth, etc.), or other requirements included in the pod specification. The requirements in the pod specification may be specified by the user at step 402, specified by a policy, included in a manifest used to create the one or more application instance 118, or some other source.

At step 416, the scheduler 206 may start a sorting stage in which the candidate nodes are sorted based on suitability to host the pod 112 defined by the pod specification. The sorting stage may include sorting based on energy utilization. For example, at step 416, the sorting stage may include entering an energy score plugin to score the candidate nodes based on expected energy utilization. In some instances, energy usage is not a priority. For example, performance requirements may outweigh potential energy savings. Accordingly, the cluster 111 may add an annotation to the pod specification when sorting based on energy utilization is required. The energy score plugin will therefore be used only when this annotation is present. Steps 418-422 may be performed by the energy score plugin or otherwise be performed only when sorting based on energy utilization is performed.

At step 418, the scheduler 206 may read the energy expenditure data for the candidate nodes from the database 208. At step 420, the scheduler 206 may read current CPU utilization for the candidate nodes from the metrics 210. As noted above, CPU utilization may also be requested directly from the candidate nodes as part of step 420.

At step 422, the scheduler 206 picks a node from among the candidate nodes based on the energy expenditure data and the CPU utilization for each node. Selecting a node from among the candidate nodes may include calculating a delta power, calculating an expected future power based on the delta power, and calculating an energy score based on the expected future power for each candidate node. The delta power (ΔP) for a candidate node may be calculated according to (1)

$$a . Δ P = P ( {C}_{f} , {U}_{f} ) - P ( {C}_{0} , {U}_{0} ) \qquad ( 1 )$$

The input arguments and function P( ) of (1) may be defined as follows:
C₀=number of CPUs currently provisioned on the candidate node (including those used by the monitor 212, operating system 214, orchestrator agent 216, and any other background processes).
U₀=current CPU utilization of the candidate node. U₀ may be the average of utilizations of all provisioned CPUs; U₀ may be the result of a rounding operation, e.g., U₀=ceil(current_CPU_utilization, 10), where current_CPU_utilization is the average of all utilization percentages of all provisioned CPUs and “ceil” rounds to the nearest multiple of 10. The rounding to compute U₀ may correspond to rounding to the values used during step 312 described above.
C_{f}=C₀+pod_request, where pod_request is a number of additional CPUs requested to be provisioned in the pod specification, which may be derived from information included in the instruction from step 402 or generated automatically. The pod_request may be a requested amount of CPUs (e.g., minimum), limit amount (e.g., maximum burstable amount), or a function of these two values.
U_{f}=U₀+expected_utilization, where expected_utilization is an expected additional CPU utilization resulting from instantiation of the one or more application instances. The value of expected_utilization may be specified by a policy, e.g., an expected increase in utilization resulting from instantiation of the one or more application instance 118 based on experimental data, such as current or past CPU utilization of another application instance 118 of the same executable. U_{f} may be the result of a rounding operation, e.g., U_{f}=ceil(U₀+expected_utilization), 10). The rounding to compute U_{f} may correspond to rounding to the values used during the benchmarking step 312 described above. In some embodiments, U_{f} may be set based on a policy to be the maximum CPU utilization (e.g., 100%).
P(C,U) is an energy expenditure according to the energy expenditure data captured during the benchmarking of step 312. E.g., the energy expenditure for a given number of CPUs C and average utilization (U). Where the benchmarking step includes other variables, current values for these variables on the candidate node may also be used as inputs to the function P( ). Where the values of C and U do not correspond to a tested test scenario, interpolation may be performed. Alternatively, the rounding used to calculate C_{f} and U_{f} may ensure that the inputs to P(C,U) correspond to a tested test scenario.

An expected future power P_{f} for a candidate node may be calculated as current_power+ΔP. The value for current_power may be measured value, e.g., using values read from the hardware registers of the candidate node either upon request of the cluster 111 or read from the metrics 210 as periodically stored there by the candidate node.

Once a value of P_{f} is obtained for each candidate node, the candidate nodes may be assigned an energy efficiency score (EES). Th EES may be a normalized score, such as a score from 0 to 100, 0 to 1, or some other interval. For example, let MinP_{f} be the smallest value of P_{f} for all of the candidate nodes and MaxP_{f} be the largest value of P_{f} for all of the candidate nodes.

A normalized future power N_{f} may be calculated for each candidate node according to (2) and the EES may be calculated by reverse normalizing the normalized future power, such as according to (3).

$$a . {N}_{f} = \frac{{P}_{f} - Min {P}_{f}}{Max {P}_{f} - Min {P}_{f}} \times R \qquad ( 2 )$$

$$b . EES = R - {N}_{f} \qquad ( 3 )$$

Note that in some embodiments, only the delta power ΔP for each node is used to calculate the EES. For example, the values of ΔP may be reverse normalized according to (4) to obtain the ΔPₙ, where MinΔP is the smallest ΔP for all of the candidate nodes and MaxΔP is the largest ΔP for all of the candidate nodes. The EES for each node may then be calculated according to ΔPₙ for each node according to (5).

$$i . Δ {P}_{n} = \frac{Δ P - Min Δ P}{Max Δ P - Min Δ P} \times R \qquad ( 4 )$$

$$ii . EES = R - Δ {P}_{n} \qquad ( 5 )$$

The candidate node with the highest EES may then be selected at step 422 as indicating the lowest power consumption. Alternatively, the normalized power N_{f} or normalized delta power ΔPₙ may be used alone and the candidate node with the lowest normalized power N_{f} or normalized delta power ΔPₙ may be selected. In such embodiments, multiplication by R may be omitted. The value of R may be 100 to give EES scores ranging from 0 to 100. The value of R may also 1 (e.g., no multiplication by R in (2)), or some other value.

At step 424 the scheduler 206 may write the node selection in the pod specification in the key-value store 204, e.g., an identifier of the selected candidate node. The identifier may be an internet protocol (IP) address or other identifier of the candidate node. At step 426, the scheduler 206 completes (e.g., ends) the sorting stage and at step 428 the scheduler completes (e.g., ends) the scheduling stage.

At step 430, the orchestration agent 216 on the candidate node detects the reference to the candidate node in the key-value store 204 and reads the pod specification from the key-value store 204. At step 432, the orchestration agent 216 will then execute functions required to bring up the pod on the selected candidate node. Step 432 may therefore include creating containers 114 for each of the one or more application instances 118, creating the one or more application instances within each of the containers 114, and performing any other configuring of the one or more containers 114 and one or more application instances 118, and commencing execution of the one or more containers 114 and one or more application instances 118.

The above-described system and methods enable selection of nodes on which to create applications in order to reduce energy expenditure. The system and methods described above facilitate the reduction of energy expenditure despite difficulties in predicting the amount of energy required to execute a given application instance. For example, the approach described above can accommodate some or all of the following factors:
Servers from different manufacturers respectively consume a different base power (e.g., power consumed with no applications executing on the server)
Servers from different manufacturers respectively consume a different CPU power at various CPU Utilizations.
Servers from the same manufacturer with different numbers of sockets and allocated CPUs will respectively consume a different base power and a different CPU Power at various CPU Utilizations.
Servers from the same manufacturer with the same number of CPUs could respectively consume a different base power because of different devices connected to a peripheral component interconnect express (PCIe) bus.
Servers from the same manufacturer with the same number of CPUs, same Base Power, and same average CPU utilization could respectively consume a different total power because of the number of applications already provisioned as they drive up the power drawn by cooling fans

Using the EES to perform dynamic placement of pods can therefore be used to reduce total energy consumption on a cluster 111 without regard to the type of application being instantiated on the cluster 111.

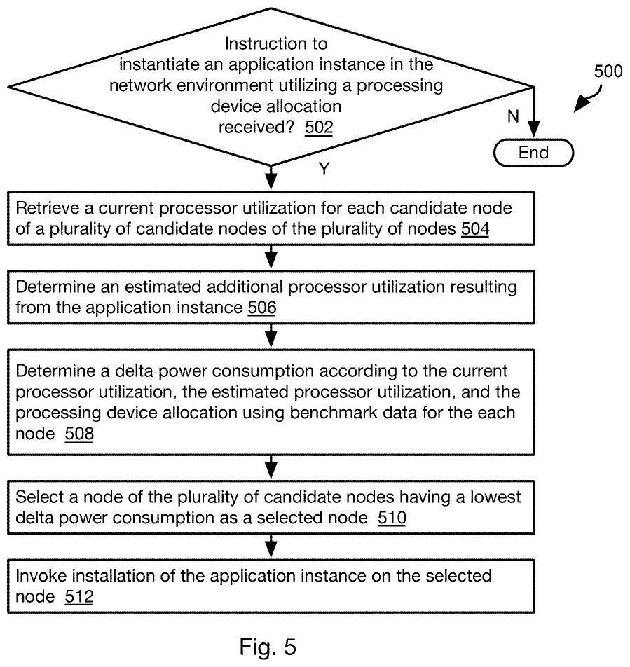

Referring to FIG. 5, in some embodiments, a method 500 may be performed by the scheduler 206. The method may include receiving 502 an instruction to instantiate an application instance in the network environment utilizing a processing device allocation (see, e.g., step 402 of the method 400). In response to receiving 502 the instruction to instantiate the application instance in the network environment, the method 500 includes performing subsequent steps of the method 500. The method 500 may include retrieving 504 a current processor utilization for each candidate node of a plurality of candidate nodes of the plurality of nodes (see, e.g., step 420 of the method 400). The method 500 may include determining 506 an estimated additional processor utilization resulting from the application instance (see, e.g., step 422 of the method 400 and corresponding description). The method 500 may include performing step 508 for each candidate node, which includes determining a delta power consumption according to the current processor utilization, the estimated additional processor utilization, and the processing device allocation using benchmark data for the each node (see, e.g., step 422 of the method 400 and corresponding description). Step 510 may include selecting a node of the plurality of candidate nodes having a lowest delta power consumption as a selected node (see, e.g., step 422 of the method 400 and corresponding description). The method 500 may include invoking, at step 512, installation of the application instance on the selected node (see, e.g., steps 424-432 of the method 400 and corresponding description).

FIG. 6 illustrates an embodiment of a computing device 600 that may be used to implement node, such as a server 102, or any other computing component described above. As shown in FIG. 6, the computing device 600 includes a processor 610, a memory 620, a storage component 630, an input component 640, an output component 650, a communication interface 660, and a bus 670.

The processor 610, as used herein, refers to any type of computational circuit that may comprise one or more hardware elements and software elements. The processor 610 may be embodied as a multi-core processor, a single core processor, or a combination of one or more multi-core processors and/or one or more single core processors, a distributed processing system, or the like. The processor 610 may be a Central Processing Unit (CPU) a graphics processing unit (GPU), an accelerated processing unit (APU), an application-specific integrated circuit (ASIC), or another type of processing component.

Memory 620 includes a non-transitory computer readable medium. Memory 620 includes a random-access memory (RAM), a read only memory (ROM), and/or another type of dynamic or static storage device (e.g., a flash memory, a magnetic memory, and/or an optical memory) that stores information (e.g., data) and/or instructions for use by processor 610. The memory 620 includes machine-readable instructions which are executable by the processor 610. These machine-readable instructions when executed by the processor 610 cause the processor 610 to perform one or more method steps of an embodiment described above.

Storage component 630 stores information and/or software related to the operation and use of the device 600. For example, storage component 630 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 640 is configured to receive information, such as user input. For example, the input component 640 may include, but not be limited to, a touch screen display, a keyboard, a keypad, a mouse, a button, a switch, and/or a microphone. Additionally, or alternatively, the input component 640 may include a sensor for sensing information (e.g., a global positioning system (GPS), an accelerometer, a gyroscope, and/or an actuator).

Output component 650 is configured to provide output information from the device 600. For example, the output component 650 may be, but not limited to, a display, a speaker, instructions to an external device, and/or one or more light-emitting diodes (LEDs).

Communication interface 660 is an interface that provides a communication connection to other devices, such as external devices and internal devices. The connection by the communication interface 660 can be a wired connection, a wireless connection, or a combination of wired and wireless connections, and can be a direct connection or an indirect connection via a communication network that exists between the device 600 and other devices. In other words, the standard of the communication interface 660 is not limited.

The bus 670 acts as an interconnect between the processor 610, the memory 620, the storage component 630, the input component 640, the output component 650, and the communication interface 660 of the device 600. The bus 670 may include a wired interconnection or a wireless interconnection.

The number and arrangement of components shown in FIG. 6 are provided as an example. In practice, device 600 may include additional components, fewer components, different components, or differently arranged components than those shown in FIG. 6. Additionally, or alternatively, a set of components (e.g., one or more components) of device 600 may perform one or more functions described as being performed by another set of components of device 600. Further, one or more method steps described in any of the embodiments may be performed utilizing a plurality of devices 600 in communication with one another.

In a first example embodiment, a system comprises: a network environment comprising a plurality of nodes, each comprising including one or more processing devices and one or more memory devices operably coupled to the one or more processing devices; and a scheduler executing in the network environment and configured to, in response to an instruction to instantiate an application instance in the network environment utilizing a processing device allocation:
retrieve a current processor utilization for each candidate node of a plurality of candidate nodes of the plurality of nodes;
determine an estimated additional processor utilization resulting from the application instance;
for each node of the plurality of candidate nodes:
determine a delta power consumption according to the current processor utilization, the estimated additional processor utilization, and the processing device allocation using benchmark data for the each node;
select a node of the plurality of candidate nodes having a lowest delta power consumption as a selected node; and
invoke installation of the application instance on the selected node.

In a second example embodiment of the first example embodiment, the network environment is a telecommunication network.

In a third example embodiment of the second example embodiment,
the plurality of nodes include distributed units (DU) and central units (CU) according to the open radio access network (O-RAN) standard.

In a fourth example embodiment of the third example embodiment, the system further comprises a service management and orchestration (SMO) platform according to the O-RAN standard executing in the network environment, the SMO configured to invoke providing the instruction to instantiate the application instance to the scheduler.

In a fifth example embodiment of the first example embodiment, the scheduler is an agent of an orchestrator.

In a sixth example embodiment of the first example embodiment, the scheduler is configured to determine the estimated additional processor utilization of the application instance by determining the estimated additional processor utilization according to a policy.

In a seventh example embodiment of the sixth example embodiment, the scheduler is configured to determine the estimated additional processor utilization of the application instance by rounding up a first estimated additional processor utilization according to the policy to one of a discrete set of possible values.

In an eighth example embodiment of the seventh example embodiment, the benchmark data includes test data corresponding to the discrete set of possible values.

In a ninth example embodiment of the eighth example embodiment, the scheduler is configured to determine the delta power consumption according to the current processor utilization, the estimated additional processor utilization, and the processing device allocation using the benchmark data for the each node by calculating the delta power consumption as a difference between a first energy expenditure according to the benchmark data for a sum of a current processing device allocation on the each node and the processing device allocation and the estimated additional processor utilization and a second energy expenditure according to the benchmark data for the current processing device allocation on the each node and the current processor utilization.

In a tenth example embodiment of the first example embodiment, the scheduler is configured to select the selected node of the plurality of candidate nodes as having the lowest delta power consumption by normalizing the delta power consumptions of the plurality of candidate nodes to obtain normalized delta power consumptions.

In an eleventh example embodiment of the tenth example embodiment, the scheduler is configured to select the selected node of the plurality of candidate nodes as having the lowest delta power consumption by: reverse normalizing the normalized delta power consumptions to obtain scores; and selecting, as the selected node, a candidate node of the plurality of candidate nodes having a highest score of the scores.

In a twelfth example embodiment of the first example embodiment, the scheduler is configured to select the selected node according to current power consumptions of the plurality of nodes, the scheduler configured to retrieve the current power consumptions of the plurality of candidate nodes by reading power consumption read from hardware registers of the plurality of candidate nodes.

In a thirteenth example embodiment, a method comprises: receiving, by a scheduler executing in the network environment, an instruction to instantiate an application instance in a network environment utilizing a processing device allocation; and in response to receiving the instruction to instantiate the application instance in the network environment, performing, by the scheduler:
retrieving a current processor utilization for each candidate node of a plurality of candidate nodes of a plurality of nodes in the network environment;
determining an estimated additional processor utilization resulting from the application instance;
for each node of the plurality of candidate nodes:
determining a delta power consumption according to the current processor utilization, the estimated additional processor utilization, and the processing device allocation using the benchmark data for the each node
select a node of the plurality of candidate nodes having a lowest delta power consumption as a selected node; and
invoke installation of the application instance on the selected node.

In a fourteenth example embodiment of the thirteenth example embodiment, the network environment is a telecommunication network; the plurality of nodes include distributed units (DU) and central units (CU) according to the open radio access network (O-RAN) standard; and receiving the instruction to instantiate the application instance is invoked by a service management and orchestration (SMO) platform according to the O-RAN standard executing in the network environment.

In a fifteenth example embodiment of the thirteenth example embodiment, the scheduler is an agent of an orchestrator, the instruction to instantiate the application instance being received from the orchestrator.

In a sixteenth example embodiment of the thirteenth example embodiment, the method further includes determining the estimated additional processor utilization of the application instance according to a policy.

In a seventeenth example embodiment of the sixteenth example embodiment, determining the estimated additional processor utilization of the application instance comprises rounding up a first estimated additional processor utilization according to the policy to one of a discrete set of possible values.

In an eighteenth example embodiment of the thirteenth example embodiment, determining the delta power consumption according to the current processor utilization, the estimated additional processor utilization, and the processing allocation using the benchmark data for the each node comprises calculating the delta power consumption as a difference between a first energy expenditure according to the benchmark data for a sum of a current processing device allocation on the each node and the processing device allocation and the estimated additional processor utilization and a second energy expenditure according to the benchmark data for the current processing device allocation on the each node and the current processor utilization.

In a nineteenth example embodiment of the thirteenth example embodiment, selecting the selected node of the plurality of candidate nodes as having the lowest delta power consumption comprises normalizing the delta power consumptions of the plurality of candidate nodes to obtain normalized delta power consumptions.

In a twentieth example embodiment, a non-transitory computer-readable medium stores executable code that, when executed by one or more processing devices, causes the one or more processing devices to: receive an instruction to instantiate an application instance in a network environment utilizing a processing device allocation; and in response to receiving the instruction to instantiate the application instance in the network environment:
retrieve a current processor utilization for each candidate node of a plurality of candidate nodes of a plurality of nodes in the network environment;
determine an estimated additional processor utilization of the application instance;
for each node of the plurality of candidate nodes:
determine a delta power consumption according to the current processor utilization, the estimated additional processor utilization, and the processing device allocation using benchmark data for the each node;
select a selected node of the plurality of candidate nodes as having a lowest delta power consumption; and
invoke installation of the application instance on the selected node.

1. A system comprising:
a network environment comprising a plurality of nodes; and
a scheduler executing in the network environment and configured to, in response to an instruction to instantiate an application instance in the network environment utilizing a processing device allocation:
retrieve a current processor utilization for each candidate node of a plurality of candidate nodes of the plurality of nodes;
determine an estimated additional processor utilization resulting from the application instance;
for each node of the plurality of candidate nodes:
determine a delta power consumption according to the current processor utilization, the estimated additional processor utilization, and the processing device allocation using benchmark data for the each node;
select a node of the plurality of candidate nodes having a lowest delta power consumption as a selected node; and
invoke installation of the application instance on the selected node.

2. The system of claim 1, wherein the network environment is a telecommunication network.

3. The system of claim 2, wherein the plurality of nodes include distributed units (DU) and central units (CU) according to the open radio access network (O-RAN) standard.

4. The system of claim 3, further comprising a service management and orchestration (SMO) platform according to the O-RAN standard executing in the network environment, the SMO configured to invoke providing the instruction to instantiate the application instance to the scheduler.

5. The system of claim 1, wherein the scheduler is an agent of an orchestrator.

6. The system of claim 1, wherein the scheduler is configured to determine the estimated additional processor utilization of the application instance by determining the estimated additional processor utilization according to a policy.

7. The system of claim 6, wherein the scheduler is configured to determine the estimated additional processor utilization of the application instance by rounding up a first estimated additional processor utilization according to the policy to one of a discrete set of possible values.

8. The system of claim 7, wherein the benchmark data includes test data corresponding to the discrete set of possible values.

9. The system of claim 8, wherein the scheduler is configured to determine the delta power consumption according to the current processor utilization, the estimated additional processor utilization, and the processing device allocation using the benchmark data for the each node by calculating the delta power consumption as a difference between a first energy expenditure according to the benchmark data for a sum of a current processing device allocation on the each node and the processing device allocation and the estimated additional processor utilization and a second energy expenditure according to the benchmark data for the current processing device allocation on the each node and the current processor utilization.

10. The system of claim 1, wherein the scheduler is configured to select the selected node of the plurality of candidate nodes as having the lowest delta power consumption by normalizing the delta power consumptions of the plurality of candidate nodes to obtain normalized delta power consumptions.

11. The system of claim 10, wherein the scheduler is configured to select the selected node of the plurality of candidate nodes as having the lowest delta power consumption by:
reverse normalizing the normalized delta power consumptions to obtain scores; and
selecting, as the selected node, a candidate node of the plurality of candidate nodes having a highest score of the scores.

12. The system of claim 1, wherein the scheduler is configured to select the selected node according to current power consumptions of the plurality of nodes, the scheduler configured to retrieve the current power consumptions of the plurality of candidate nodes by reading power consumption read from hardware registers of the plurality of candidate nodes.

13. A method comprising:
receiving, by a scheduler executing in a network environment, an instruction to instantiate an application instance in the network environment utilizing a processing device allocation; and
in response to receiving the instruction to instantiate the application instance in the network environment, performing, by the scheduler:
retrieving a current processor utilization for each candidate node of a plurality of candidate nodes of a plurality of nodes in the network environment;
determining an estimated additional processor utilization resulting from the application instance;
for each node of the plurality of candidate nodes:
determining a delta power consumption according to the current processor utilization, the estimated additional processor utilization, and the processing device allocation using benchmark data for the each node;
selecting a node of the plurality of candidate nodes having a lowest delta power consumption as a selected node; and
invoking installation of the application instance on the selected node.

14. The method of claim 13, wherein:
the network environment is a telecommunication network;
the plurality of nodes include distributed units (DU) and central units (CU) according to the open radio access network (O-RAN) standard; and
receiving the instruction to instantiate the application instance is invoked by a service management and orchestration (SMO) platform according to the O-RAN standard executing in the network environment.

15. The method of claim 13, wherein the scheduler is an agent of an orchestrator, the instruction to instantiate the application instance being received from the orchestrator.

16. The method of claim 13, further comprising determining the estimated additional processor utilization of the application instance according to a policy.

17. The method of claim 16, wherein determining the estimated additional processor utilization of the application instance comprises rounding up a first estimated additional processor utilization according to the policy to one of a discrete set of possible values.

18. The method of claim 13, wherein determining the delta power consumption according to the current processor utilization, the estimated additional processor utilization, and the processing device allocation using the benchmark data for the each node as a difference between a first energy expenditure according to the benchmark data for a sum of a current processing device allocation on the each node and the processing device allocation and the estimated additional processor utilization and a second energy expenditure according to the benchmark data for the current processing device allocation on the each node and the current processor utilization.

19. The method of claim 13, wherein selecting the selected node of the plurality of candidate nodes as having the lowest delta power consumption comprises normalizing the delta power consumptions of the plurality of candidate nodes to obtain normalized delta power consumptions.

20. A non-transitory computer-readable medium storing executable code that, when executed by one or more processing devices, causes the one or more processing devices to:
receive an instruction to instantiate an application instance in a network environment utilizing a processing device allocation; and
in response to receiving the instruction to instantiate the application instance in the network environment:
retrieve a current processor utilization for each candidate node of a plurality of candidate nodes of a plurality of nodes in the network environment;
determine an estimated additional processor utilization resulting from the application instance;
for each node of the plurality of candidate nodes:
determine a delta power consumption according to the current processor utilization, the estimated additional processor utilization, and the processing device allocation using benchmark data for the each node;
select a node of the plurality of candidate nodes having a lowest delta power consumption as a selected node; and
invoke installation of the application instance on the selected node.
